(19) United States
(12) Patent Application Publication
(10) Pub. No.: US 2023/0120899 A1
(43) Pub. Date: Apr. 20, 2023

(54) WIND SPEED SPECIFICATION SYSTEM, WIND SPEED SPECIFICATION DEVICE, AND WIND SPEED SPECIFICATION METHOD

(71) Applicant: NEC Corporation, Minato-ku, Tokyo (JP)

(72) Inventors: Koyo MORI, Tokyo (JP); Yoshiaki AONO, Tokyo (JP); Yukihide YODA, Tokyo (JP)

(73) Assignee: NEC Corporation, Minato-ku, Tokyo (JP)

(21) Appl. No.: 17/798,229

(22) PCT Filed: Feb. 28, 2020
(86) PCT No.: PCT/JP2020/008443

§ 371 Date: Aug. 8, 2022

(51) Int. Cl. G01S 15/58; G01S 7/56; G01S 7/521; G01K 13/024

(52) U.S. Cl. CPC G01S 15/582; G01K 13/024; G01S 7/56; G01S 7/521

(57) ABSTRACT

A wind speed specification system according to the present disclosure includes an optical fiber (10) laid around a power transmission line (40), a reception unit (20) that receives an optical signal including information indicating a sound generated when an airflow hits the optical fiber (10), from the optical fiber (10), and a specification unit (32) that specifies a wind speed around the optical fiber (10), based on information indicating a sound that is included in the optical signal.

### TECHNICAL FIELD

The present disclosure relates to a wind speed specification system, a wind speed specification device, and a wind speed specification method.

### BACKGROUND ART

As for power transmission lines, power transmission efficiency changes depending on an external environmental factor such as a temperature and a wind speed, and a power transmission capacity changes accordingly. Therefore, in the present state, a value of current flowing through the power transmission line is determined to be a certain unique value, and power is transmitted. Therefore, there is room for improvement in terms of efficiency of power transmission lines.

Recently, a technique called dynamic rating, in which external environmental factors of a power transmission line are constantly monitored and a transmission capacity thereof is changed according to the external environmental factors, has attracted attention. In order to perform dynamic rating, information on external environmental factors such as a temperature and a wind speed is required.

Meanwhile, a technique called optical fiber sensing using an optical fiber as a sensor has attracted attention, and various proposals using the optical fiber sensing have been made.

For example, Patent Literature 1 discloses a technique of calculating a temperature and a wind speed by using an optical fiber. In detail, the technique disclosed in Patent Literature 1 uses an optical fiber including a first measurement unit and a second measurement unit that have different thermal capacities and the like of a coating layer. Then, a temperature of each of the first measurement unit and the second measurement unit is measured based on an optical signal received from the optical fiber, and a wind speed is calculated based on a ratio of a fluctuation width of the temperature of the first measurement unit to a fluctuation width of the temperature of the second measurement unit.

### CITATION LIST

### Patent Literature

[Patent Literature 1] International Patent Publication No. WO 2011/104828

### SUMMARY OF INVENTION

### Technical Problem

As described above, in the technique disclosed in Patent Literature 1, a wind speed around the optical fiber is calculated from temperature information around the optical fiber.

Meanwhile, in order to perform dynamic rating with higher accuracy, it is necessary to cope with changes in external environmental factors in a timely manner.

However, as in the technique disclosed in Patent Literature 1, when a wind speed around the optical fiber is calculated from temperature information around the optical fiber, there is a problem that it is difficult to detect a rapid change in wind speed because a possibility of occurrence of a rapid change in temperature is low.

From this, it is considered that, even when the technique disclosed in Patent Literature 1 is used, the dynamic rating with high accuracy may not be performed because it is difficult to timely cope with a change in wind speed.

Therefore, in order to improve accuracy of the dynamic rating, it is desired to detect a wind speed with higher real-time property.

Therefore, an object of the present disclosure is to solve the above-mentioned problem and provide a wind speed specification system, a wind speed specification device, and a wind speed specification method that are capable of detecting a wind speed with higher real-time property.

### SOLUTION TO PROBLEM

A wind speed specification system according to one aspect includes: an optical fiber laid around a power transmission line; a reception unit that receives an optical signal from the optical fiber, the optical signal including information indicating a sound generated when an airflow hits the optical fiber; and a specification unit that specifies a wind speed around the optical fiber, based on information indicating the sound included in the optical signal.

A wind speed specification device according to one aspect includes: an acquisition unit that acquires information indicating a sound generated by an airflow hitting an optical fiber laid around a power transmission line, the information being included in an optical signal received from the optical fiber; and a specification unit that specifies a wind speed around the optical fiber, based on the information indicating the sound.

A wind speed specification method according to one aspect is a wind speed specification method by a wind speed specification system, and includes: a reception step of receiving, from an optical fiber laid around a power transmission line, an optical signal including information indicating a sound generated when an airflow hits the optical fiber; and a specification step of specifying a wind speed around the optical fiber, based on the information indicating the sound and being included in the optical signal.

### ADVANTAGEOUS EFFECTS OF INVENTION

According to the above-mentioned aspects, it is possible to achieve an effect of providing a wind speed specification system, a wind speed specification device, and a wind speed specification method that are capable of detecting a wind speed with higher real-time property.

### BRIEF DESCRIPTION OF DRAWINGS

FIG. 1 is a diagram illustrating a configuration example of a wind speed specification system according to a first example embodiment;

FIG. 2 is a diagram illustrating an example of information indicating an aeolian sound, which is included in an optical signal received by a reception unit according to the first example embodiment;

FIG. 3 is a diagram illustrating an example of information indicating an aeolian sound, which is included in an optical signal received by a reception unit according to the first example embodiment;

FIG. 4 is a diagram illustrating an example of information indicating an aeolian sound, which is included in an optical signal received by a reception unit according to the first example embodiment;

FIG. 5 is a flow chart illustrating an example of an operation flow of the wind speed specification system according to the first example embodiment;

FIG. 6 is a flow chart illustrating an example of an operation flow of a wind speed specification system according to a second example embodiment;

FIG. 7 is a diagram illustrating a configuration example of a wind speed specification system according to a third example embodiment;

FIG. 8 is a flow chart illustrating an example of an operation flow of the wind speed specification system according to the third example embodiment;

FIG. 9 is a diagram illustrating a configuration example of a wind speed specification system according to a fourth example embodiment;

FIG. 10 is a diagram illustrating an example of a GUI screen to be displayed on a display unit by a report unit according to the fourth example embodiment;

FIG. 11 is a flow chart illustrating an example of an operation flow of the wind speed specification system according to the fourth example embodiment;

FIG. 12 is a diagram illustrating a configuration example of a wind speed specification system according to another example embodiment; and

FIG. 13 is a block diagram illustrating a configuration example of computer hardware that achieves the wind speed specification device according to each of the example embodiments.

### EXAMPLE EMBODIMENT

Example embodiments of the present disclosure will be described below with reference to the drawings. Note that the following description and the drawings are appropriately omitted and simplified for clarity of description. In the following drawings, the same elements are denoted by the same reference numerals, and a repetitive description thereof is omitted as necessary.

### First Example Embodiment

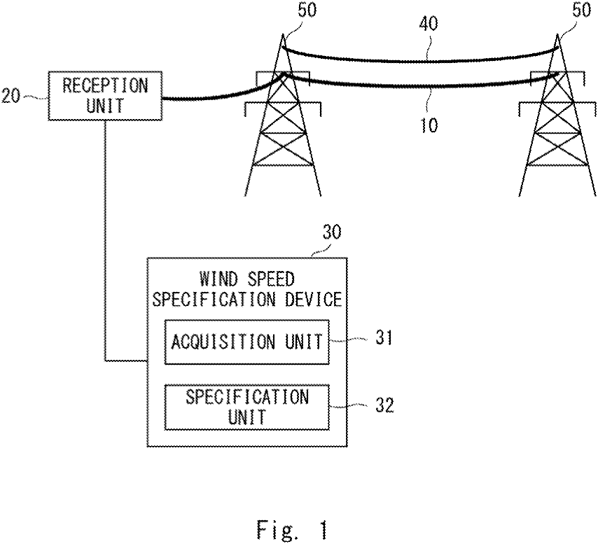

First, with reference to FIG. 1, a configuration example of a wind speed specification system according to a first example embodiment will be described.

As illustrated in FIG. 1, the wind speed specification system according to the first example embodiment includes an optical fiber 10, a reception unit 20, and a wind speed specification device 30. The wind speed specification device 30 includes an acquisition unit 31 and a specification unit 32. The wind speed specification device 30 can be disposed at a position away from the reception unit 20, and can be disposed on a cloud, for example.

The optical fiber 10 is laid on a plurality of steel towers 50 (two steel towers 50 in FIG. 1) on which the power transmission line 40 is laid, and one end of the optical fiber 10 is connected to the reception unit 20. In FIG. 1, the optical fiber 10 is provided on a lower side of the power transmission line 40, but may be provided on an upper side of the power transmission line 40. Further, the optical fiber 10 is not limited to being laid on the steel towers 50, and can be laid by an optional method as long as it is laid around the power transmission line 40.

The optical fiber 10 may be an optical fiber dedicated for sensing, or may be an optical fiber for both communication and sensing. When the optical fiber 10 is an optical fiber for both communication and sensing, an optical signal for sensing is demultiplexed by a filter, which is not illustrated, at a front stage of the reception unit 20, and only the optical signal for sensing can be received by the reception unit 20. In FIG. 1, only one optical fiber 10 is provided, but a plurality of optical fibers 10 may be provided.

The reception unit 20 receives an optical signal (an optical signal for sensing; the same shall apply hereinafter,) from the optical fiber 10. For example, the reception unit 20 makes the pulse light incident on the optical fiber 10, and receives backscattered light generated as the pulse light is transmitted through the optical fiber 10, as an optical signal.

Herein, it is known that when an air flow hits a thin rod, a Kalman vortex is generated behind the rod, thereby generating an aeolian sound (wind noise). Since the optical fiber 10 generally has a small diameter, the airflow of wind hits the optical fiber 10, and thus an aeolian sound is also generated around the optical fiber 10.

When an aeolian sound is generated around the optical fiber 10, the aeolian sound and vibration generated in association with the aeolian sound are transmitted to the optical fiber 10. As a result, the optical signal to be transmitted through the optical fiber 10 changes in characteristics (e.g., a wavelength). Therefore, the optical fiber 10 can detect the aeolian sound generated around the optical fiber 10, and the optical signal received by the reception unit 20 includes information indicating the aeolian sound detected by the optical fiber 10. The information indicating the aeolian sound includes not only the information indicating the sound itself of the aeolian sound but also the information indicating the vibration generated in association with the aeolian sound.

The acquisition unit 31 acquires information indicating the aeolian sound generated around the optical fiber 10, which is included in the optical signal received by the reception unit 20.

The specification unit 32 specifies a wind speed around the optical fiber 10, based on the information indicating the aeolian sound generated around the optical fiber 10, which is acquired by the acquisition unit 31.

At this time, the specification unit 32 can specify a position (distance of the optical fiber 10 from the reception unit 20) at which an optical signal including the information indicating the aeolian sound is generated, in the following manner. For example, the specification unit 32 can specify the position at which the optical signal is generated, based on a time difference between a time at which the pulse light is made incident on the optical fiber 10 by the reception unit 20 and a time at which the optical signal is received. Alternatively, the specification unit 32 can specify the position at which the optical signal is generated, based on a reception intensity of the optical signal received by the reception unit 20. For example, as the reception intensity of the optical signal is smaller, the specification unit 32 specifies the position at which the optical signal is generated as a position farther from the reception unit 20.

The specification of the generation position of the optical signal is not limited to that performed by the specification unit 32. For example, the reception unit 20 may specify the generation position of the optical signal, and the acquisition unit 31 may acquire information on the generation position of the optical signal from the reception unit 20.

Hereinafter, a method of specifying the wind speed around the optical fiber 10 by the specification unit 32 will be described in detail.

The information indicating the aeolian sound generated around the optical fiber 10 includes an acoustic pattern of the aeolian sound and a vibration pattern of the vibration generated in association with the aeolian sound. The acoustic pattern of the aeolian sound and the vibration pattern of the vibration generated in association with the aeolian sound become an inherent dynamic fluctuation pattern that dynamically fluctuates in accordance with the wind speed around the optical fiber 10. For example, the vibration pattern of the vibration generated in association with the aeolian sound is a fluctuation pattern in which the strength of the vibration, a vibration position, a fluctuation transition of a frequency, and the like are different in accordance with the wind speed around the optical fiber 10.

Therefore, the specification unit 32 can specify the wind speed around the optical fiber 10, based on the acoustic pattern of the aeolian sound or the vibration pattern of the vibration generated in association with the aeolian sound, for example, in the following manner. Hereinafter, an example of specifying the wind speed by using the vibration pattern of the vibration generated in association with the aeolian sound will be described.

### (A) Method A

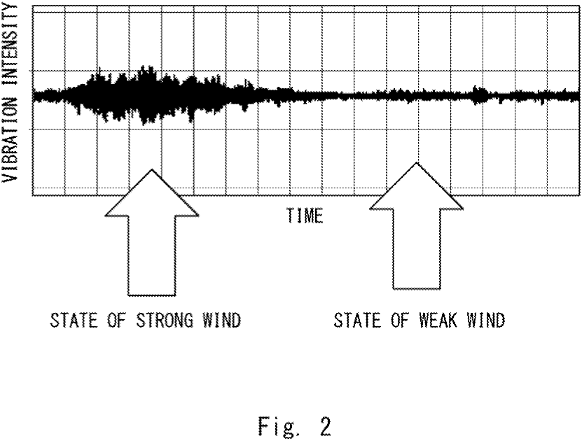

First, the acquisition unit 31 acquires information as illustrated in FIG. 2, as information indicating an aeolian sound generated around the optical fiber 10, which is included in the optical signal received by the reception unit 20. FIG. 2 illustrates vibration characteristics of vibrations generated in association with an aeolian sound at a certain position on the optical fiber 10, wherein a horizontal axis indicates a time and a vertical axis indicates a vibration intensity.

In the vibration pattern included in the information of FIG. 2, a fluctuation width of amplitude intensity is large in a state in which the wind is strong, and the fluctuation width of the amplitude intensity is small in a state in which the wind is weak. Therefore, the specification unit 32 specifies the wind speed around the optical fiber 10, based on the fluctuation width of the vibration intensity.

### (B) Method B

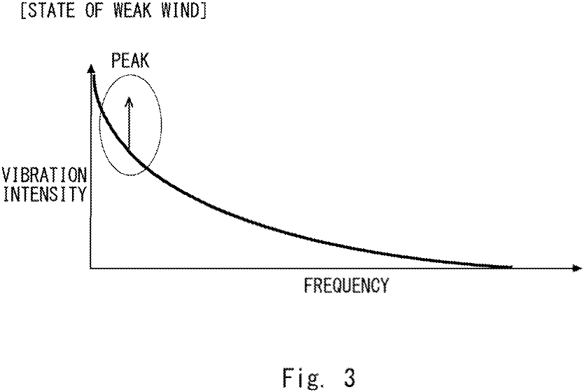

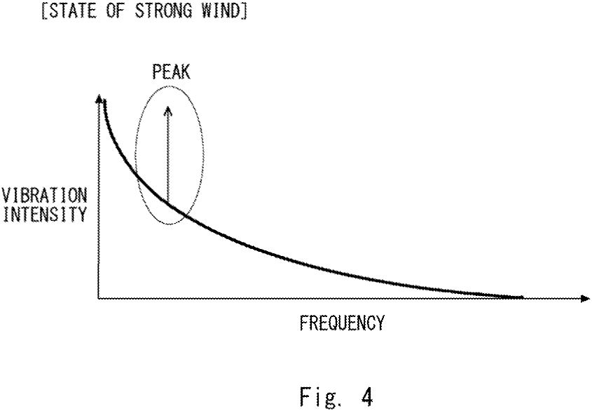

First, the acquisition unit 31 acquires information as illustrated in FIGS. 3 and 4, as the information indicating the aeolian sound generated around the optical fiber 10, which is included in the optical signal received by the reception unit 20. FIGS. 3 and 4 illustrate frequency characteristics of vibration generated in association with the aeolian sound at a certain position on the optical fiber 10, wherein a horizontal axis indicates a frequency and a vertical axis indicates a vibration intensity.

In the vibration pattern included in the information of FIGS. 3 and 4, a peak of the vibration intensity occurs. A magnitude of the peak of the vibration intensity and a frequency at which this peak occurs differ depending on a state of wind. More specifically, in a state where the wind is strong (FIG. 4), the magnitude of the peak of the vibration intensity is larger, and the frequency at which this peak occurs is shifted to a high frequency side, as compared to a state where the wind is weak (FIG. 3). Therefore, the specification unit 32 specifies the wind speed around the optical fiber 10, based on the magnitude of the peak of the vibration intensity and the frequency at which this peak occurs. In FIGS. 3 and 4, the frequency at which the peak of the vibration intensity occurs is shifted to the high frequency side as the wind is stronger, but may be shifted to a low frequency side as the wind is stronger depending on a laying condition of the optical fiber 10 or the like.

### (C) Method C

The specification unit 32 stores in advance, for each of a plurality of wind speeds, a vibration pattern (e.g., a vibration pattern similar to any one of FIGS. 2 to 4) of vibration actually generated when being at the wind speed in a memory, which is not illustrated, or the like as a matching pattern.

First, the acquisition unit 31 acquires information indicating an aeolian sound generated around the optical fiber 10, which is included in an optical signal received by the reception unit 20.

Subsequently, the specification unit 32 compares a vibration pattern included in the information acquired by the acquisition unit 31 (e.g., a vibration pattern similar to any one of FIGS. 2 to 4) with the matching pattern. When there is a matching pattern whose matching ratio with the vibration pattern is equal to or greater than a threshold value among the matching patterns, the specification unit 32 determines that the wind speed is related to the matching pattern.

### (D) Method D

The specification unit 32 prepares, for each of a plurality of wind speeds, a set of teacher data indicating a wind speed and a vibration pattern (e.g., a vibration pattern similar to any one of FIGS. 2 to 4) of vibration actually generated when being at the wind speed, inputs each prepared set, constructs a learning model by a convolutional neural network (CNN) in advance, and stores the learning model in advance in a memory, which is not illustrated, or the like.

First, the acquisition unit 31 acquires information indicating an aeolian sound generated around the optical fiber 10, which is included in an optical signal received by the reception unit 20.

Subsequently, the specification unit 32 inputs a vibration pattern included in the information acquired by the acquisition unit 31 (e.g., a vibration pattern similar to any one of FIGS. 2 to 4) to the learning model. Thus, the specification unit 32 acquires a wind speed as an output result of the learning model.

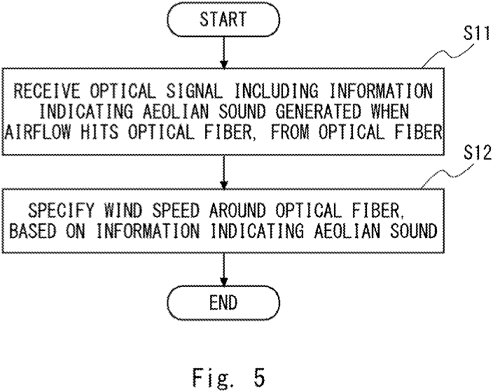

Next, an example of an operation flow of the wind speed specification system according to the first example embodiment will be described with reference to FIG. 5.

As illustrated in FIG. 5, the reception unit 20 receives, from the optical fiber 10, an optical signal including information indicating an aeolian sound generated by an airflow of wind hitting the optical fiber 10 (step S11).

Next, the acquisition unit 31 acquires the information indicating the aeolian sound, which is included in the optical signal received by the reception unit 20, and the specification unit 32 specifies a wind speed around the optical fiber 10, based on the information indicating the aeolian sound (step S12). At this time, for example, the specification unit 32 may specify the wind speed by using any one of the methods A to D described above.

As described above, according to the first example embodiment, the reception unit 20 receives, from the optical fiber 10, an optical signal including information indicating an aeolian sound generated by the airflow of wind hitting the optical fiber 10. The specification unit 32 specifies the wind speed around the optical fiber 10, based on the information indicating the aeolian sound, which is included in the optical signal.

In other words, according to the first example embodiment, instead of specifying the wind speed from the temperature information around the optical fiber 10, the wind speed around the optical fiber 10 is specified in real time from the information indicating the aeolian sound generated around the optical fiber 10, which is included in the optical signal. This makes it possible to detect the wind speed with higher real-time property.

### Second Example Embodiment

A wind speed specification system according to a second example embodiment has a configuration itself similar to that of the first example embodiment described above, but extends a function of the specification unit 32.

Specifically, the specification unit 32 has a function of specifying a direction of the airflow of wind, based on the information indicating the aeolian sound generated around the optical fiber 10.

As described above, the acoustic pattern of the aeolian sound generated around the optical fiber 10 and the vibration pattern of the vibration generated in association with the aeolian sound fluctuate depending on the wind speed around the optical fiber 10. However, the acoustic pattern and the vibration pattern also fluctuate depending on the direction of the airflow around the optical fiber 10.

Therefore, the specification unit 32 can specify the direction of the airflow around the optical fiber 10, based on the acoustic pattern of the aeolian sound generated around the optical fiber 10 and the vibration pattern of the vibration generated in association with the aeolian sound.

As a method of specifying the direction of the airflow around the optical fiber 10 in the specification unit 32, for example, a method of using a matching pattern as in the method C described above or a method of using a learning model as in the method D described above can be considered.

When the matching pattern is used as in the method C described above, for each of a plurality of directions of airflow, the vibration pattern of the vibration actually generated when being in the direction is stored in advance in the memory or the like as the matching pattern. Other matters may be the same as in the method C described above.

Further, when the learning model is used as in the method D described above, for each of a plurality of directions of airflow, a set of teacher data indicating the direction of the airflow and the vibration pattern of the vibration actually generated when being in the direction is prepared, and each set prepared is input, and the learning model is constructed in advance and stored in advance in a memory or the like. Other matters may be the same as in the method D described above.

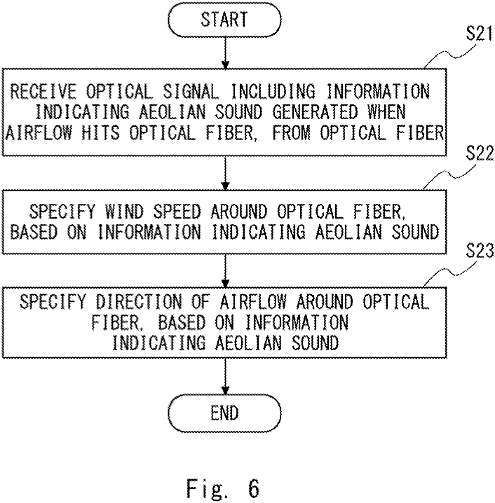

Next, an example of an operation flow of the wind speed specification system according to the second example embodiment will be described with reference to FIG. 6.

As illustrated in FIG. 6, first, steps S21 and S22 similar to steps S11 and S12 in FIG. 5 are performed.

Next, the specification unit 32 specifies a direction of the airflow around the optical fiber 10, based on the information indicating the aeolian sound, which is included in the optical signal. At this time, for example, the specification unit 32 may specify the direction of the airflow by using any one of the above-described methods using the matching pattern and the learning model.

As described above, according to the second example embodiment, the specification unit 32 specifies the direction of the airflow around the optical fiber 10, based on the information indicating the aeolian sound, which is included in the optical signal. As a result, not only the wind speed around the optical fiber 10 but also the direction of the airflow can be specified.

Other effects are the same as those of the first example embodiment described above.

### Third Example Embodiment

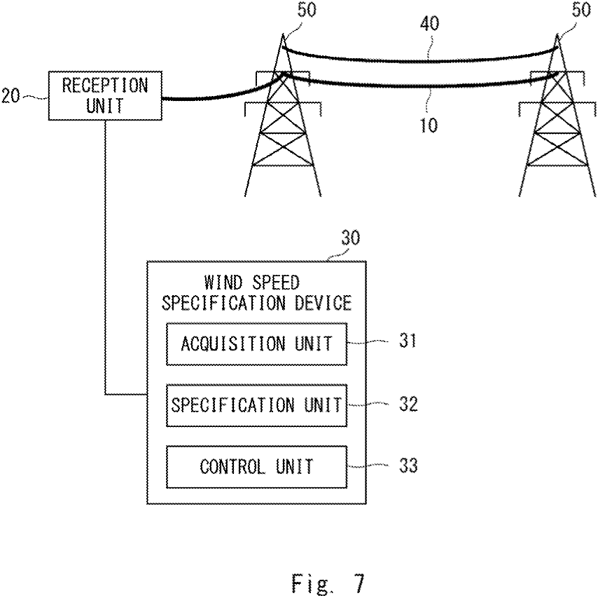

Next, a configuration example of a wind speed specification system according to a third example embodiment will be described with reference to FIG. 7.

As illustrated in FIG. 7, the wind speed specification system according to the third example embodiment differs from the configurations of the first and second example embodiments described above in that a control unit 33 is added to the inside of a wind speed specification device 30. In FIG. 7, the control unit 33 is provided inside the wind speed specification device 30, but may be provided outside the wind speed specification device 30.

The control unit 33 controls a power transmission capacity of a power transmission line 40, based on a wind speed around an optical fiber 10, which is specified by a specification unit 32. For example, the control unit 33 controls a power transmission capacity of the power transmission line 40 by transmitting a command value of a voltage or current depending on the power transmission capacity of the power transmission line 40 to an unillustrated device that adjusts the voltage or the current of the power transmission line 40.

Herein, the wind speed specified by the specification unit 32 is the wind speed around the optical fiber 10. Therefore, the control unit 33 can specify stress applied to the optical fiber 10 by the wind speed specified by the specification unit 32.

However, in order to perform dynamic rating with higher accuracy, it is necessary to specify stress applied to the power transmission line 40 by the wind speed specified by the specification unit 32, and determine the power transmission capacity of the power transmission line 40, based on the stress applied to the power transmission line 40.

Therefore, when the wind speed around the optical fiber 10 is the wind speed specified by the specification unit 32, the control unit 33 estimates the stress applied to the power transmission line 40, based on a positional relationship between the optical fiber 10 and the power transmission line 40, and the like. Then, the control unit 33 determines the power transmission capacity of the power transmission line 40, based on the estimated stress applied to the power transmission line 40.

At this time, the control unit 33 may hold an association table indicating an association relationship between the wind speed around the optical fiber 10 and the stress applied to the power transmission line 40 at that time. Using this association table, the control unit 33 may estimate the stress applied to the power transmission line 40 from the wind speed around the optical fiber 10 which is specified by the specification unit 32.

When the specification unit 32 has a function of specifying a direction of airflow around the optical fiber 10, the control unit 33 may control the power transmission capacity of the power transmission line 40, based on the wind speed and the direction of the airflow around the optical fiber 10, which are specified by the specification unit 32. At this time, when the wind speed and the direction of the airflow around the optical fiber 10 are the wind speed and the direction of the airflow specified by the specification unit 32, the control unit 33 estimates the stress applied to the power transmission line 40, and may determine the power transmission capacity of the power transmission line 40, based on the estimated stress. The method of estimating the stress at this time may be the same as that described above.

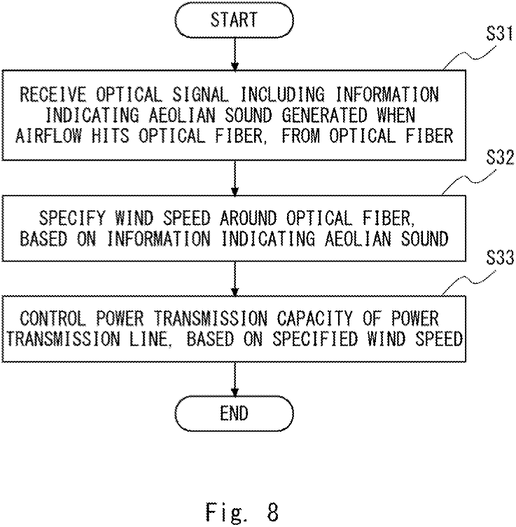

Next, an example of an operation flow of the wind speed specification system according to the third example embodiment will be described with reference to FIG. 8. Herein, it is assumed that the specification unit 32 is the specification unit 32 according to the first example embodiment described above, and does not have a function of specifying the direction of the airflow.

As illustrated in FIG. 8, first, steps S31 and S32 similar to steps S11 and S12 in FIG. 5 are performed.

Next, the control unit 33 controls the power transmission capacity of the power transmission line 40, based on the wind speed around the optical fiber 10 which is specified by the specification unit 32 (step S33). At this time, for example, as described above, the control unit 33 may estimate the stress applied to the power transmission line 40, and determine the power transmission capacity of the power transmission line 40, based on the estimated stress. In addition, as described above, the control unit 33 may control the power transmission capacity of the power transmission line 40 by transmitting a command value of the voltage or the current depending on the power transmission capacity of the power transmission line 40 to an unillustrated device that adjusts the voltage or the current of the power transmission line 40.

As described above, according to the third example embodiment, the control unit 33 controls the power transmission capacity of the power transmission line 40, based on the wind speed around the optical fiber 10 which is specified by the specification unit 32. Herein, as described above, the wind speed that is specified by the specification unit 32 becomes a wind speed with higher real-time property. Therefore, by controlling the power transmission capacity of the power transmission line 40, based on the wind speed with higher real-time property, it is possible to perform dynamic rating with higher accuracy.

Other effects are the same as those of the first example embodiment described above.

### Fourth Example Embodiment

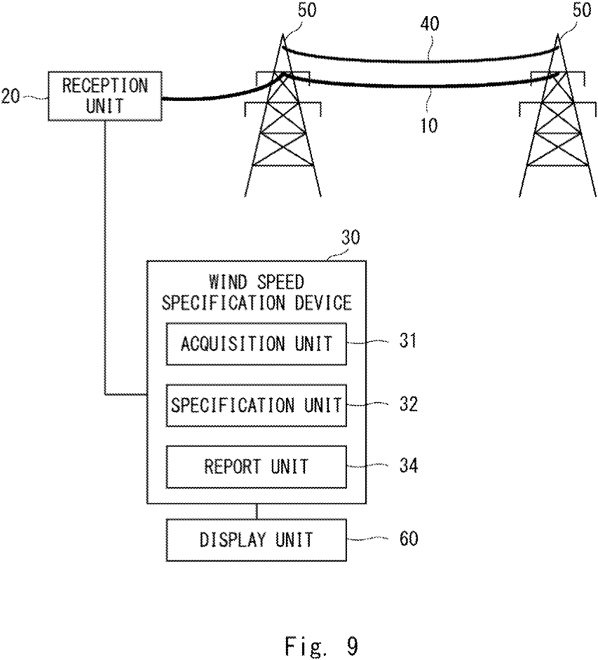

Next, a configuration example of a wind speed specification system according to a fourth example embodiment will be described with reference to FIG. 9.

As illustrated in FIG. 9, the wind speed specification system according to the fourth example embodiment is different from the configurations of the first and second example embodiments described above in that a display unit 60 is added and in that a report unit 34 is added to the inside of a wind speed specification device 30.

The display unit 60 is installed in a communication station building, an operation center, or the like, and is a display, a monitor, or the like that displays various types of information.

The report unit 34 holds in advance information indicating a laying position of an optical fiber 10, information indicating a laying position of a power transmission line 40, and map information in association with each other.

Herein, as described above, a specification unit 32 can specify a generation position of an optical signal (a distance of the optical fiber 10 from a reception unit 20).

Therefore, the report unit 34 causes the display unit 60 to display a graphical user interface (GUI) screen on which information of a wind speed and an airflow direction specified by the specification unit 32 is superimposed based on information indicating an aeolian sound, which is included in the optical signal, at the generation position of the optical signal specified by the specification unit 32 on a map.

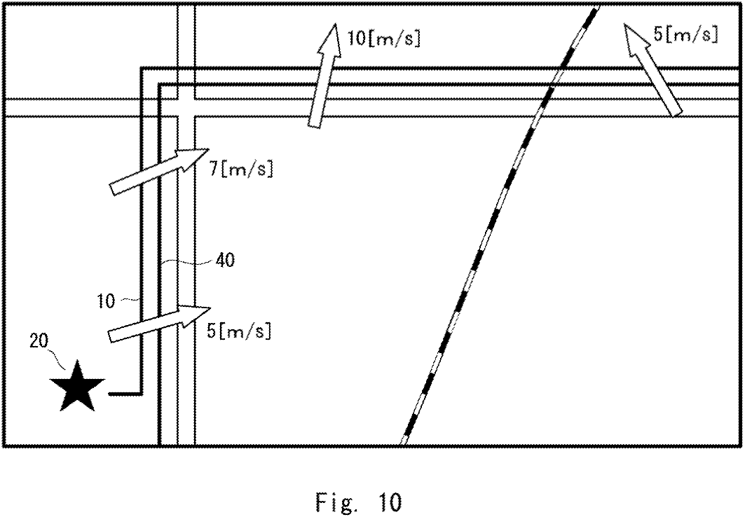

FIG. 10 illustrates an example of a GUI screen to be displayed on the display unit 60 by the report unit 34. It is assumed that a map on the GUI screen of FIG. 10 can be enlarged or reduced as necessary.

As illustrated in FIG. 10, at the generation position of the optical signal on the map, information of the wind speed and the direction of the airflow which are specified based on the information indicating the aeolian sound, which is included in the optical signal, is superimposed. In the example of FIG. 10, the information of the wind speed is indicated by a numerical value, and the information of the direction of the airflow is indicated by an arrow. In the example of FIG. 10, information indicating the laying positions of the optical fiber 10 and the power transmission line 40 is also superimposed on the map. In the example of FIG. 10, information indicating a position of the reception unit 20 is superimposed as an asterisk on the map.

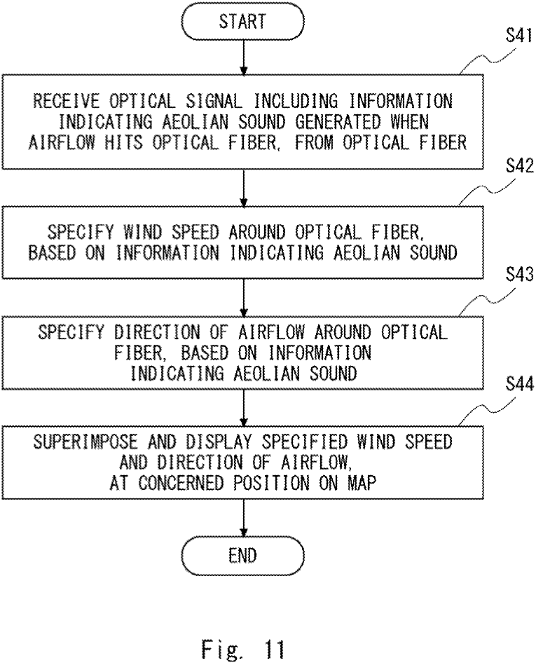

Next, an example of an operation flow of the wind speed specification system according to the fourth example embodiment will be described with reference to FIG. 11.

As illustrated in FIG. 11, first, steps S41 to S43 similar to steps S21 to S23 in FIG. 6 are performed.

Next, the report unit 34 superimposes the information of the wind speed and the airflow direction specified by the specification unit 32, based on the information indicating the aeolian sound, which is included in the optical signal, at the generation position of the optical signal specified by the specification unit 32 on the map, and displays the superimposed information on the display unit 60 (step S44). This display may be performed by, for example, a GUI screen illustrated in FIG. 10.

As described above, according to the fourth example embodiment, the report unit 34 superimposes the information of the wind speed and the airflow direction that are specified based on the information indicating the aeolian sound which is included in the optical signal, at the generation position of the optical signal on the map, and displays the superimposed information on the display unit 60. As a result, it is possible to inform the communication station, the operation center, and the like in which the display unit 60 is installed of the wind speed and the airflow direction at each position on the map.

Other effects are the same as those of the second example embodiment described above.

### Other Example Embodiments

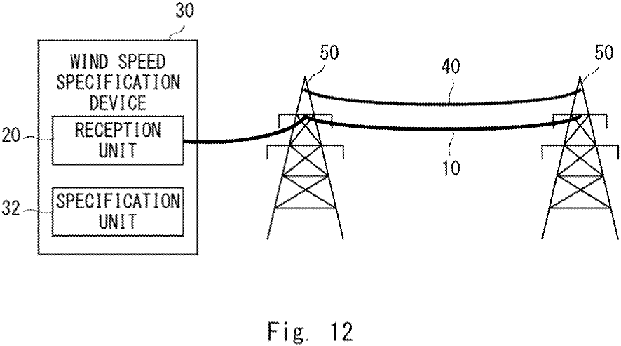

In the example embodiments described above, the reception unit 20 and the wind speed specification device 30 are separated from each other, but the present invention is not limited thereto. The reception unit 20 and the wind speed specification device 30 may be integrated, and the reception unit 20 may be provided inside the wind speed specification device 30. FIG. 12 illustrates a configuration example of a wind speed specification system in which the reception unit 20 is provided inside the wind speed specification device 30. In the example of FIG. 12, since the reception unit 20 and the specification unit 32 are provided inside the same wind speed specification device 30, the acquisition unit 31 is removed. In the wind speed specification system illustrated in FIG. 12, the control unit 33 may be added to the inside of the wind speed specification device 30 as in the third example embodiment described above, or the display unit 60 may be added and the report unit 34 may be added to the inside of the wind speed specification device 30 as in the fourth example embodiment described above.

In the example embodiment described above, the control unit 33 controls the power transmission capacity of the power transmission line 40, based on the wind speed around the optical fiber 10, or based on the wind speed and the airflow direction around the optical fiber 10, but the present invention is not limited thereto.

As temperature changes around the optical fiber 10, an optical signal transmitted through the optical fiber 10 changes in characteristics (e.g., a wavelength). Therefore, the optical fiber 10 can detect the temperature around the optical fiber 10, and an optical signal received by the reception unit 20 includes information indicating a temperature detected by the optical fiber 10. Therefore, the specification unit 32 can specify the temperature around the optical fiber 10, based on information indicating the temperature around the optical fiber 10, which is included in the optical signal received by the reception unit 20.

Therefore, the control unit 33 may control the power transmission capacity of the power transmission line 40, based on the wind speed and temperature around the optical fiber 10, or based on the wind speed, the direction of the airflow, and the temperature around the optical fiber 10. In this manner, by further using the information of the temperature around the optical fiber 10, it is possible to perform dynamic rating with higher accuracy.

In each of the example embodiments described above, one reception unit 20 and one wind speed specification device 30 are provided, but the present invention is not limited thereto. For example, when a plurality of optical fibers 10 are provided, a plurality of reception units 20 and a plurality of wind speed specification devices 30 may be provided in association with each of the plurality of optical fibers 10.

### Hardware Configuration of Wind Speed Specification Device According to Example Embodiment

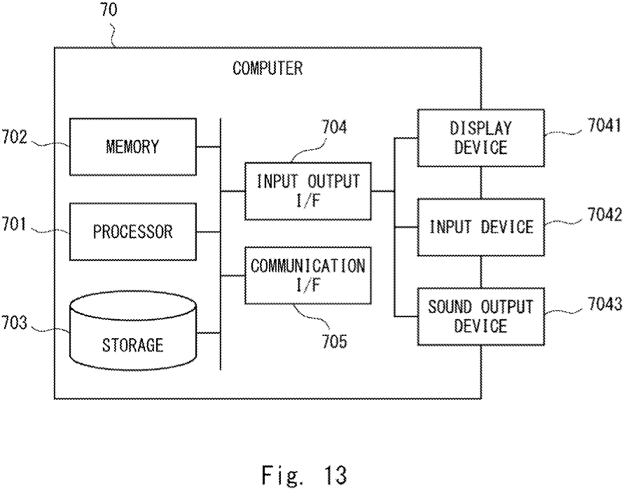

Next, with reference to FIG. 13, a hardware configuration of a computer 70 that achieves the wind speed specification device 30 according to each of the above-described example embodiments will be described.

As illustrated in FIG. 13, the computer 70 includes a processor 701, a memory 702, a storage 703, an input/output interface (input/output I/F) 704, a communication interface (communication I/F) 705, and the like. The processor 701, the memory 702, the storage 703, the input/output interface 704, and the communication interface 705 are connected to each other through a data transmission path for transmitting and receiving data.

The processor 701 is an arithmetic processing unit such as a Central Processing Unit (CPU) or a Graphics Processing Unit (GPU), for example. The memory 702 is, for example, a memory such as a Random Access Memory (RAM), a Read Only Memory (ROM). The storage 703 is, for example, a storage device such as a Hard Disk Drive (HDD), a Solid State Drive (SSD), or a memory card. The storage 703 may be a memory such as a RAM or a ROM.

The storage 703 stores a program for achieving the functions of the constituent elements included in the wind speed specification device 30. The processor 701 executes these programs and thereby achieves the functions of the constituent elements included in the wind speed specification device 30. Herein, when executing the programs described above, the processor 701 may read these programs onto the memory 702 and then execute them, or may execute them without reading them onto the memory 702. The memory 702 and the storage 703 also serve to store information and data held by the constituent elements included in the wind speed specification device 30.

Also, the programs described above may be stored and provided to a computer (including the computer 70) by using various types of non-transitory computer readable media. The non-transitory computer readable media include various types of tangible storage media. Examples of the non-transitory computer readable media include magnetic recording media (e.g., flexible disk, magnetic tape, hard disk drive), magneto-optical recording media (e.g., magneto-optical disk), Compact Disc-ROM (CD-ROM), CD-Recordable (CD-R), CD-ReWritable (CD-R/W), semiconductor memory (e.g., Mask ROM, Programmable ROM (PROM), Erasable PROM (EPROM), Flash ROM, and RAM. The program may also be supplied to a computer by various types of transitory computer readable media. Examples of the transitory computer-readable media include electrical signals, optical signals, and electromagnetic waves. The transitory computer readable medium may provide the program to the computer via a wired communication path such as an electrical wire and an optical fiber, or a wireless communication path.

The input/output interface 704 is connected to a display device 7041, an input device 7042, a sound output device 7043, and the like. The display device 7041 is a device that displays a screen associated to drawing data processed by the processor 701, such as a Liquid Crystal Display (LCD), a Cathode Ray Tube (CRT) display, or a monitor. The input device 7042 is a device that accepts an operation input by an operator, and is, for example, a keyboard, a mouse, a touch sensor, or the like. The display device 7041 and the input device 7042 may be integrated and achieved as a touch panel. The sound output device 7043 is a device that acoustically outputs a sound associated to acoustic data processed by the processor 701, such as a speaker.

The communication interface 705 transmits and receives data to and from an external device. For example, the communication interface 705 communicates with an external device via a wired communication path or a wireless communication path.

Although the present disclosure has been described above with reference to the example embodiments, the present disclosure is not limited to the example embodiments described above. Various modifications may be made to the structure and details of the present disclosure as will be understood by those skilled in the art within the scope of the present disclosure.

For example, some or all of the above-described example embodiments may be used in combination with each other.

In addition, the whole or part of the example embodiments disclosed above can be described as, but not limited to, the following supplementary notes.

### Supplementary Note 1

A wind speed specification system comprising:
an optical fiber laid around a power transmission line;
a reception unit configured to receive an optical signal from the optical fiber, the optical signal including information indicating a sound generated when an airflow hits the optical fiber; and
a specification unit configured to specify a wind speed around the optical fiber, based on the information indicating the sound, the information being included in the optical signal.

### Supplementary Note 2

The wind speed specification system according to Supplementary Note 1, wherein the specification unit specifies a direction of the airflow, based on information indicating the sound.

### Supplementary Note 3

The wind speed specification system according to Supplementary Note 2, further comprising a control unit configured to control a power transmission capacity of the power transmission line, based on the wind speed specified by the specification unit.

### Supplementary Note 4

The wind speed specification system according to Supplementary Note 3, wherein
the specification unit specifies the temperature, based on information indicating a temperature around the optical fiber, the information being included in the optical signal, and
the control unit controls a power transmission capacity of the power transmission line, based on the wind speed and the temperature that are specified by the specification unit.

### Supplementary Note 5

The wind speed specification system according to any one of Supplementary Notes 2 to 4, further comprising:
a display unit; and
a report unit, wherein
the specification unit specifies a position at which the optical signal is generated, based on the optical signal, and
the report unit superimposes information of the wind speed and the direction of the airflow that are specified by the specification unit, at a position specified by the specification unit on a map, and displays the superimposed information on the display unit.

### Supplementary Note 6

A wind speed specification device comprising:
an acquisition unit configured to acquire information indicating a sound generated when an airflow hits an optical fiber laid around a power transmission line, the information being included in an optical signal received from the optical fiber; and
a specification unit configured to specify a wind speed around the optical fiber, based on the information indicating the sound.

### Supplementary Note 7

The wind speed specification device according to Supplementary Note 6, wherein the specification unit specifies a direction of the airflow, based on the information indicating the sound.

### Supplementary Note 8

The wind speed specification device according to Supplementary Note 7, further comprising a control unit configured to control a power transmission capacity of the power transmission line, based on the wind speed specified by the specification unit.

### Supplementary Note 9

The wind speed specification device according to Supplementary Note 8, wherein
the specification unit specifies the temperature, based on information indicating a temperature around the optical fiber, the information being included in the optical signal, and
the control unit controls a power transmission capacity of the power transmission line, based on the wind speed and the temperature that are specified by the specification unit.

### Supplementary Note 10

The wind speed specification device according to any one of Supplementary Notes 7 to 9, further comprising a report unit, wherein
the specification unit specifies a position at which the optical signal is generated, based on the optical signal, and
the report unit superimposes information of the wind speed and the direction of the airflow that are specified by the specification unit, at a position specified by the specification unit on a map, and displays the superimposed information on a display unit.

### Supplementary Note 11

A wind speed specification method by a wind speed specification system, comprising:
a reception step of receiving an optical signal from an optical fiber laid around a power transmission line, the optical signal including information indicating a sound generated when an airflow hits the optical fiber; and
a specification step of specifying a wind speed around the optical fiber, based on the information indicating the sound, the information being included in the optical signal.

### Supplementary Note 12

The wind speed specification method according to Supplementary Note 11, wherein the specification step further includes specifying a direction of the airflow, based on the information indicating the sound.

### Supplementary Note 13

The wind speed specification method according to Supplementary Note 12, further comprising a control step of controlling a power transmission capacity of the power transmission line, based on the wind speed specified in the specification step.

### Supplementary Note 14

The wind speed specification method according to Supplementary Note 13, wherein
the specification step further includes specifying the temperature, based on information indicating a temperature around the optical fiber, the information being included in the optical signal, and
the control step further includes controlling a power transmission capacity of the power transmission line, based on the wind speed and the temperature that are specified in the specification step.

### Supplementary Note 15

The wind speed specification method according to any one of Supplementary Notes 12 to 14, wherein the specification step further includes specifying a position at which the optical signal is generated, based on the optical signal, the wind speed specification method further comprising

a report step of superimposing information of the wind speed and the direction of the airflow that are specified in the specification step, at a position specified in the specification step on a map, and displaying the superimposed information on a display unit.

### REFERENCE SIGNS LIST

10 OPTICAL FIBER
20 RECEPTION UNIT
30 WIND SPEED SPECIFICATION DEVICE
31 ACQUISITION UNIT
32 SPECIFICATION UNIT
33 CONTROL UNIT
34 REPORT UNIT
40 POWER TRANSMISSION LINE
50 STEEL TOWER
60 DISPLAY UNIT
70 COMPUTER
701 PROCESSOR
702 MEMORY
703 STORAGE
704 INPUT/OUTPUT INTERFACE
7041 DISPLAY DEVICE
7042 INPUT DEVICE
7043 SOUND OUTPUT DEVICE
705 COMMUNICATION INTERFACE

What is claimed is:

1. A wind speed specification system comprising:
an optical fiber laid around a power transmission line;
a reception unit configured to receive an optical signal from the optical fiber, the optical signal including information indicating a sound generated when an airflow hits the optical fiber; and
a specification unit configured to specify a wind speed around the optical fiber, based on the information indicating the sound, the information being included in the optical signal.

2. The wind speed specification system according to claim 1, wherein the specification unit specifies a direction of the airflow, based on information indicating the sound.

3. The wind speed specification system according to claim 2, further comprising a control unit configured to control a power transmission capacity of the power transmission line, based on the wind speed specified by the specification unit.

4. The wind speed specification system according to claim 3, wherein
the specification unit specifies the temperature, based on information indicating a temperature around the optical fiber, the information being included in the optical signal, and
the control unit controls a power transmission capacity of the power transmission line, based on the wind speed and the temperature that are specified by the specification unit.

5. The wind speed specification system according to claim 2, further comprising:
a display unit; and
a report unit, wherein
the specification unit specifies a position at which the optical signal is generated, based on the optical signal, and
the report unit superimposes information of the wind speed and the direction of the airflow that are specified by the specification unit, at a position specified by the specification unit on a map, and displays the superimposed information on the display unit.

6. A wind speed specification device comprising:
an acquisition unit configured to acquire information indicating a sound generated when an airflow hits an optical fiber laid around a power transmission line, the information being included in an optical signal received from the optical fiber; and
a specification unit configured to specify a wind speed around the optical fiber, based on the information indicating the sound.

7. The wind speed specification device according to claim 6, wherein the specification unit specifies a direction of the airflow, based on the information indicating the sound.

8. The wind speed specification device according to claim 7, further comprising a control unit configured to control a power transmission capacity of the power transmission line, based on the wind speed specified by the specification unit.

9. The wind speed specification device according to claim 8, wherein
the specification unit specifies the temperature, based on information indicating a temperature around the optical fiber, the information being included in the optical signal, and
the control unit controls a power transmission capacity of the power transmission line, based on the wind speed and the temperature that are specified by the specification unit.

10. The wind speed specification device according to claim 7, further comprising a report unit, wherein
the specification unit specifies a position at which the optical signal is generated, based on the optical signal, and
the report unit superimposes information of the wind speed and the direction of the airflow that are specified by the specification unit, at a position specified by the specification unit on a map, and displays the superimposed information on a display unit.

11. A wind speed specification method by a wind speed specification system, comprising:
a reception step of receiving an optical signal from an optical fiber laid around a power transmission line, the optical signal including information indicating a sound generated when an airflow hits the optical fiber; and
a specification step of specifying a wind speed around the optical fiber, based on the information indicating the sound, the information being included in the optical signal.

12. The wind speed specification method according to claim 11, wherein the specification step further includes specifying a direction of the airflow, based on the information indicating the sound.

13. The wind speed specification method according to claim 12, further comprising a control step of controlling a power transmission capacity of the power transmission line, based on the wind speed specified in the specification step.

14. The wind speed specification method according to claim 13, wherein
the specification step further includes specifying the temperature, based on information indicating a temperature around the optical fiber, the information being included in the optical signal, and
the control step further includes controlling a power transmission capacity of the power transmission line, based on the wind speed and the temperature that are specified in the specification step.

15. The wind speed specification method according to claim 12, wherein the specification step further includes specifying a position at which the optical signal is generated, based on the optical signal, the wind speed specification method further comprising
a report step of superimposing information of the wind speed and the direction of the airflow that are specified in the specification step, at a position specified in the specification step on a map, and displaying the superimposed information on a display unit.
